(19) United States
(12) Patent Application Publication
(10) Pub. No.: US 2003/0159065 A1
(43) Pub. Date: Aug. 21, 2003

(54) APPARATUS AND METHOD FOR INSPECTING THE COPYRIGHT OF DIGITAL DATA ON A NETWORK, AND RECORDING MEDIUM ON WHICH IS RECORDED A COPYRIGHT INSPECTION PROGRAM

(76) Inventors: AKIRA NAKAGAWA, KAWASAKI-SHI (JP); KYOICHI HOSOYA, KAWASAKI-SHI (JP); HIDEAKI WATANABE, KAWASAKI-SHI (JP); KIMIHIKO KAZUI, KAWASAKI-SHI (JP); EISHI MORIMATSU, KAWASAKI-SHI (JP); KIICHI MATSUDA, KAWASAKI-SHI (JP)

Correspondence Address: STAAS & HALSEY LLP, SUITE 700, 1201 NEW YORK AVENUE, N.W., WASHINGTON, DC, 20005, US

(21) Appl. No.: 09/185,506

(22) Filed: Nov. 4, 1998

(30) Foreign Application Priority Data
Feb. 24, 1998 (JP) 10-042396

(51) Int. Cl. H04L 9/00

(52) U.S. Cl. 713/201

(57) ABSTRACT

A copyright inspection apparatus, a copyright inspection method and recording medium on which is recorded a copyright inspection program, for inspecting the copyright of digital data on a network, which can automatically inspect the copyright of digital data provided on a network using a hyperlink for setting a reference path.

### BACKGROUND OF THE INVENTION

1. Field of the Invention

The present invention relates to technology for automatically inspecting the copyright of digital data provided on a network.

2. Description of the Related Art

Recently, with the progress of computer technology, it has become possible to handle data such as voice, image, and text as digital data using a computer. Furthermore, with computer systems which make up a network, for example with the Internet, it has become easy to download digital data.

With digital data however, since it is possible to easily create a copy without the accompanying degradation, then improper use where copying and modification and the like is carried out without authorisation of the copyright owner, is increasing.

Therefore, mainly from the point of protecting the copyright, there has been a development of technology referred to as electronic watermarking, where copyright information is embedded in the digital data in a form which cannot be recognized by a person. Electronic watermarking is realized for example, taking an image as an example, by appending a signal to the components of an image which is difficult to see by anyone.

However, in the case where digital data in which copyright information is embedded is inspected to determine if unauthorized use, for example on the Internet, has been made, the following problems arise. That is to say, in the case where the copyright information is inspected with conventional technology, then for a home page where there is the possibility of unauthorized use, a person must inspect this manually. However, since with the Internet, very large home pages are being instituted, then in reality it is not possible to inspect the copyright for the whole home page. There is thus the situation that inspection for improper use of the digital data cannot be adequately carried out.

### SUMMARY OF THE INVENTION

The present invention takes into consideration the above problems with the conventional technology, with the object of being able to automatically inspect the copyright of digital data provided on a network, using a hyperlink for setting a reference path.

Moreover, it is an object of the invention to distribute a recording medium on which is recorded a copyright inspection program according to the present invention, so that a person acquired such a recording medium can easily construct a copyright inspection apparatus.

According to a first aspect of the invention for achieving the above object, there is provided an apparatus for inspecting the copyright of digital data on a network comprising; a data providing device for providing digital data on the network, and a copyright inspection device for taking out copyright information from the digital data provided by the data providing device, and inspecting the copyright of the digital data based on the taken out copyright information, and in which is set a hyperlink for enabling reference from one data providing device to a referenced data providing device, wherein the apparatus further comprises; a hyperlink information take out device for taking out hyperlink information from the data providing device which provides the digital data, when the copyright of the digital data has been inspected by the copyright inspection device, and a recursive activation device for recursively activating the copyright inspection device with respect to the referenced data providing device which is specified by the hyperlink information taken out by the hyperlink information take out device.

With such a construction when the copyright of digital data provided by the data providing device is inspected, hyperlink information is taken out from the data providing device. The copyright inspection device for inspecting the copyright of the digital data is then recursively activated with respect to the referenced data providing device which is specified by the taken out hyperlink information. That is to say, the copyright of the digital data is inspected one by one by recursively activating the copyright inspection device while tracing the hyperlink from one data providing device to the referenced data providing device. Consequently, by merely specifying at least one data providing device and activating the copyright inspection device, the copyright of the digital data provided on the network can be automatically inspected.

Moreover, the construction may be such that there is provided an activation recording device for recording the data providing device for providing the digital data for which the copyright has been inspected, when the copyright inspection device is activated by the recursive activation device, and the recursive activation device skips activation of the copyright inspection device with respect to the data providing device recorded in the activation recording device.

With such a construction, when the copyright inspection device is recursively activated, the data providing device for which the copyright has been inspected is recorded in the activation recording device. Then, activation of the copyright inspection device with respect to the data providing device recorded in the activation recording device, is skipped. That is to say inspection of the copyright of the digital data is only carried out once with respect to one data providing device. Consequently, even if hyperlinks are set mutually between the data providing devices, repeated activation of the copyright inspection device with the tracing of the same hyperlinks can be prevented.

Furthermore, the construction may be such that there is provided an attribute recording device for recording attributes of digital data for which the copyright has been inspected by the copyright inspection device, and an attribute take out device for taking out the attribute of the digital data for which the copyright is to be inspected by the copyright inspection device, and the copyright inspection device inspects the copyright of the digital data when the attribute taken out by the attribute take out device and the attribute recorded in the attribute recording device do not match.

With such a construction, once the copyright of the digital data has been inspected by the copyright inspection device, the attribute of the inspected digital data is recorded in the attribute recording device. Then, only when the attribute of the digital data for which the copyright is to be inspected, and the attribute of the digital data recorded in the attribute recording device do not match, is inspection of the copyright of the digital data carried out. This utilizes a fact that, when an alteration or the like of the digital data is carried out between the previous inspection of the copyright and the current inspection of the copyright, the change of the attribute of the digital data occurs. That is to say, in the case where the attribute of the digital data being the object of inspection, and the attribute of the digital data recorded in the attribute recording device match, it can be judged that alteration or the like of the digital data has not been made. Consequently, by not carrying out inspection of the copyright with respect to the digital data for which alteration or the like has not been made, inspection efficiency can be improved.

Alternatively, the construction may be such that there is provided an automatic activation device for automatically activating the copyright inspection device in accordance with a previously set schedule.

With such a construction, the copyright inspection device is automatically activated in accordance with the previously set schedule. Consequently, inspection of copyright of the digital data is automatically carried out, and hence the time taken by a user carrying out inspection can be reduced.

According to a second aspect of the invention, there is provided a method of inspecting the copyright of digital data on a network comprising; a data providing step for providing digital data on the network, and a copyright inspection step for taking out copyright information from the digital data provided by the data providing step, and inspecting the copyright of the digital data based on the taken out copyright information, and in which is set a hyperlink for enabling reference from one data providing step to a referenced data providing step, wherein the method further comprises; a hyperlink information take out step for taking out hyperlink information from the data providing step which provides the digital data, when the copyright of the digital data has been inspected by the copyright inspection step, and a recursive activation step for recursively activating the copyright inspection step with respect to the referenced data providing step which is specified by the hyperlink information taken out by the hyperlink information take out step.

With such a construction, when the copyright of digital data provided by the data providing step is inspected, hyperlink information is taken out from the data providing step. The copyright inspection step for inspecting the copyright of the digital data is then recursively activated with respect to the referenced data providing step which is specified by the taken out hyperlink information. That is to say, the copyright of the digital data is inspected one by one by recursively activating the copyright inspection step while tracing the hyperlink from one data providing step to the referenced data providing step. Consequently, by merely specifying at least one data providing step and activating the copyright inspection step, the copyright of the digital data provided on the network can be automatically inspected.

Moreover, the construction may be such that there is provided an activation recording step for recording the data providing step for providing the digital data for which the copyright has been inspected, when the copyright inspection step is activated by the recursive activation step, and the recursive activation step skips activation of the copyright inspection step with respect to the data providing step recorded in the activation recording step.

With such a construction, when the copyright inspection step is recursively activated, the data providing step for which the copyright has been inspected is recorded in the activation recording step. Then, activation of the copyright inspection step with respect to the data providing step recorded in the activation recording step, is skipped. That is to say inspection of the copyright of the digital data is only carried out once with respect to one data providing step. Consequently, even if hyperlinks are set mutually between the data providing steps, repeated activation of the copyright inspection step with the tracing of the same hyperlinks can be prevented.

Furthermore, the construction may be such that there is provided an attribute recording step for recording attributes of digital data for which the copyright has been inspected by the copyright inspection step, and an attribute take out step for taking out the attribute of the digital data for which the copyright is to be inspected by the copyright inspection step, and the copyright inspection step inspects the copyright of the digital data when the attribute taken out by the attribute take out step and the attribute recorded in the attribute recording step do not match.

With such a construction, once the copyright of the digital data has been inspected by the copyright inspection step, the attribute of the inspected digital data is recorded in the attribute recording step. Then, only when the attribute of the digital data for which the copyright is to be inspected, and the attribute of the digital data recorded in the attribute recording step do not match, is inspection of the copyright of the digital data carried out. This utilizes a fact that, when an alteration or the like of the digital data is carried out between the previous inspection of the copyright and the current inspection of the copyright, the change of the attribute of the digital data occurs. That is to say, in the case where the attribute of the digital data being the object of inspection, and the attribute of the digital data recorded in the attribute recording device match, it can be judged that alteration or the like of the digital data has not been made. Consequently, by not carrying out inspection of the copyright with respect to the digital data for which alteration or the like has not been made, inspection efficiency can be improved.

Alternatively, the construction may be such that there is provided an automatic activation step for automatically activating the copyright inspection step in accordance with a previously set schedule.

With such a construction, the copyright inspection step is automatically activated in accordance with the previously set schedule. Consequently, inspection of copyright of the digital data is automatically carried out, and hence the time taken by a user carrying out inspection can be reduced.

According to a third aspect of the invention, there is provided a recording medium on which is recorded a program for inspecting the copyright of digital data on a network comprising; a data providing function for providing digital data on the network, and a copyright inspection function for taking out copyright information from the digital data provided by the data providing function, and inspecting the copyright of the digital data based on the taken out copyright information, and in which is set a hyperlink for enabling reference from one data providing function to a referenced data providing function, wherein the program further realizes; a hyperlink information take out function for taking out hyperlink information from the data providing function which provides the digital data, when the copyright of the digital data has been inspected by the copyright inspection function, and a recursive activation function for recursively activating the copyright inspection function with respect to the referenced data providing function which is specified by the hyperlink information taken out by the hyperlink information take out function.

Here for the recording medium, a medium which can reliably record electronic information and from which the electronic information can be reliably taken out as required is desirable. For example, a portable medium such as a magnetic tape, magnetic disc, magnetic drum, IC card or CD-ROM is appropriate.

With such a construction, a copyright inspection program for realizing a data providing function, a copyright inspection function, a hyperlink information take out function, and a recursive activation function is recorded on a recording medium. Consequently, with a recording medium on which a program for realizing the various functions is recorded, then for example, the various functions can be given to a standard computer, and hence the digital data copyright inspection apparatus according to the present invention can be easily constructed.

Moreover, the construction may be such that there is provided an activation recording function for recording the data providing function for providing the digital data for which the copyright has been inspected, when the copyright inspection function is activated by the recursive activation function, and the recursive activation function skips activation of the copyright inspection function with respect to the data providing function recorded in the activation recording function.

With such a construction, when the copyright inspection function is recursively activated, the data providing function for which the copyright has been inspected is recorded in the activation recording function. Then, activation of the copyright inspection function with respect to the data providing function recorded in the activation recording function, is skipped. That is to say inspection of the copyright of the digital data is only carried out once with respect to one data providing function. Consequently, even if hyperlinks are set mutually between the data providing functions, repeated activation of the copyright inspection function with the tracing of the same hyperlinks can be prevented.

Furthermore, the construction may be such that there is provided an attribute recording function for recording attributes of digital data for which the copyright has been inspected by the copyright inspection function, and an attribute take out function for taking out the attribute of the digital data for which the copyright is to be inspected by the copyright inspection function, and the copyright inspection function inspects the copyright of the digital data when the attribute taken out by the attribute take out function and the attribute recorded in the attribute recording function do not match.

With such a construction, once the copyright of the digital data has been inspected by the copyright inspection function, the attribute of the inspected digital data is recorded in the attribute recording function. Then, only when the attribute of the digital data for which the copyright is to be inspected, and the attribute of the digital data recorded in the attribute recording function do not match, is inspection of the copyright of the digital data carried out. This utilizes a fact that, when an alteration or the like of the digital data is carried out between the previous inspection of the copyright and the current inspection of the copyright, the change of the attribute of the digital data occurs. That is to say, in the case where the attribute of the digital data being the object of inspection, and the attribute of the digital data recorded in the attribute recording function match, it can be judged that alteration or the like of the digital data has not been made. Consequently, by not carrying out inspection of the copyright with respect to the digital data for which alteration or the like has not been made, inspection efficiency can be improved.

Alternatively, the construction may be such that there is provided an automatic activation function for automatically activating the copyright inspection function in accordance with a previously set schedule.

With such a construction, the copyright inspection function is automatically activated in accordance with the previously set schedule. Consequently, inspection of copyright of the digital data is automatically carried out, and hence the time taken by a user carrying out inspection can be reduced.

Other objects, and aspects of the present invention will become apparent from the following description of embodiments given in conjunction with the appended drawings.

### BRIEF DESCRIPTION OF THE DRAWINGS

FIG. 1 is a system diagram showing an embodiment of a copyright inspection apparatus according to the present invention;

FIG. 2 is a diagram showing an example of an HTML document describing a home page;

FIG. 3 is a diagram showing the home page displayed by the HTML document of FIG. 2;

FIG. 4 is a diagram for explaining copyright information embedded in digital data;

FIG. 5 is a diagram for explaining digital data attributes;

FIG. 6 is a diagram for explaining a link table file;

FIG. 7 is a flow chart for a main routine showing copyright inspection processing;

FIG. 8 is a flow chart for a subroutine showing copyright inspection processing; and

FIG. 9 is a flow chart for a subroutine showing copyright inspection processing.

### DESCRIPTION OF THE PREFERRED EMBODIMENT

As follows is a detailed description of the present invention, with reference to the appended drawings.

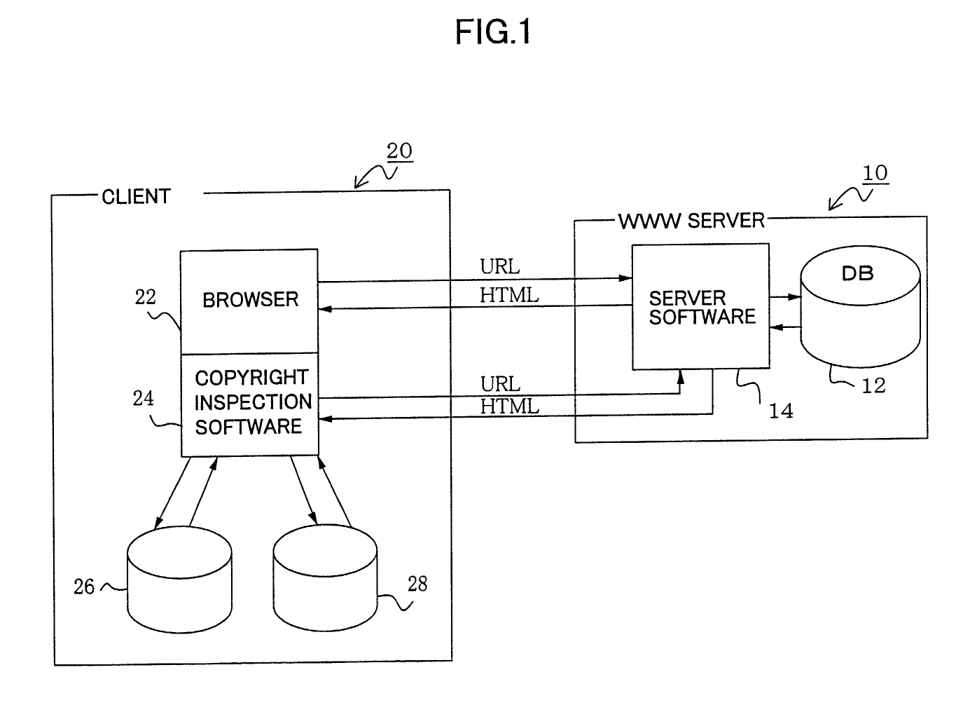

FIG. 1 shows a system structure of an embodiment where the copyright inspection apparatus according to the present invention is realized on the Internet. The Internet comprises a WWW (World Wide Web) server 10 and a client 20. The WWW server 10 and the client 20 are computers incorporating at least a central processing unit (CPU) and a memory, which execute programs in the memory.

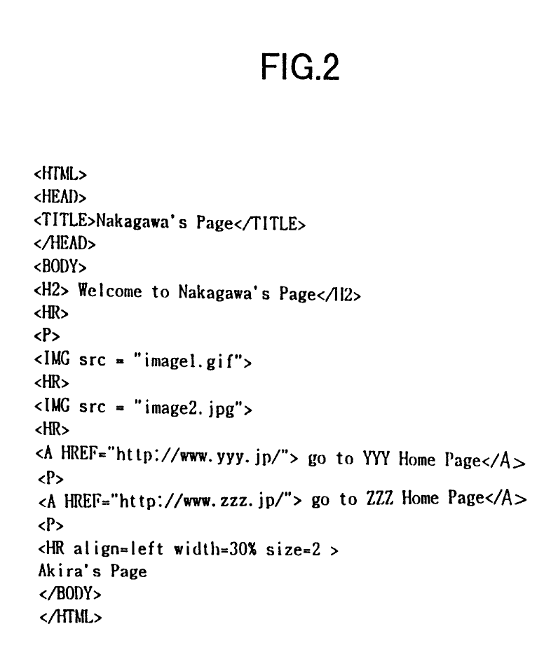

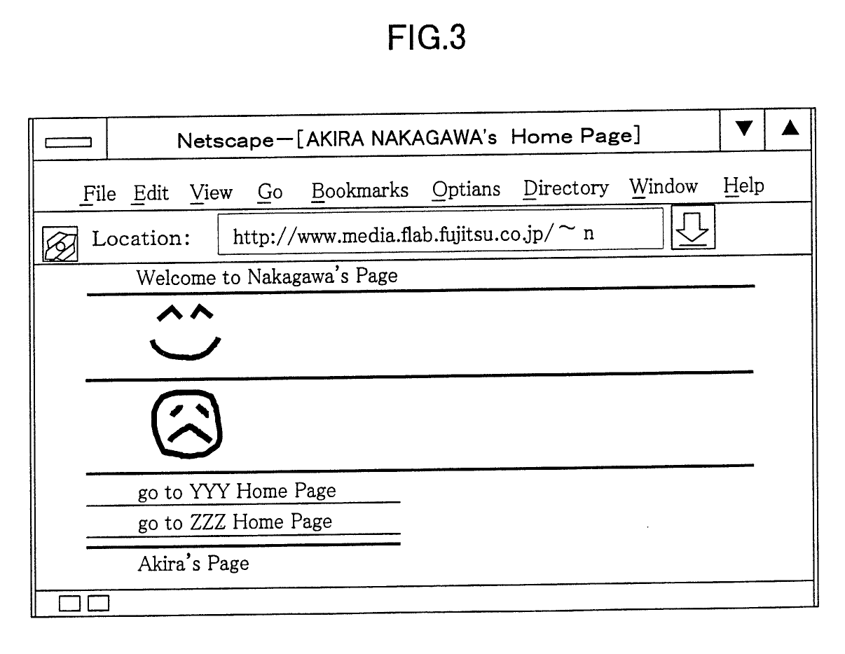

The WWW server 10 comprises a database 12 and server software 14. In the database 12 is stored documents described by Hyper Text Markup Language (referred to hereunder as “HTML”). An HTML document is described for example as shown in FIG. 2, representing the Internet home page (data providing device, data providing step, data providing function) shown in FIG. 3 . With the home page, optional digital data, for example images, and voice, etc. can be provided. Moreover, with the home page, a hyperlink can be set for enabling reference to another home page. With the home page of FIG. 2, the hyperlink for referable home pages is set by a description method such as <A “HREF=“HTTP://www.yyy.jp/”> go to YYY Home Page </A>, <A HREF=“HTTP://www.zzz.jp/”> go to ZZZ Home Page </A>. That is to say, YYY home page and ZZZ home page are referable.

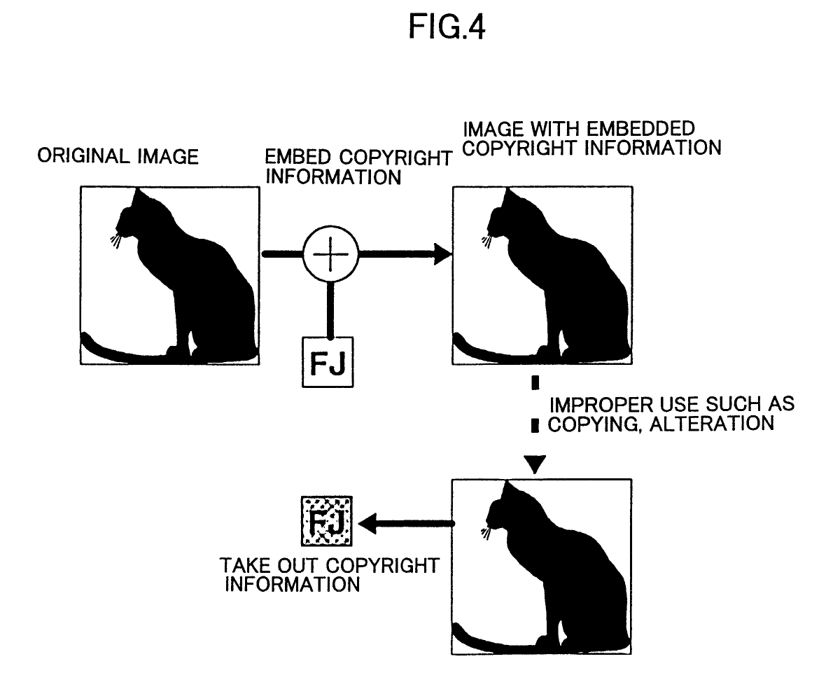

Furthermore, as shown in FIG. 4, copyright information can be embedded in the digital data. For example, copyright information “FJ” to be is embedded in an original image in a form which cannot be recognized by a person. Then, when the copyright is inspected, the copyright information “FJ” being the object of inspection is taken out from the image, and the resemblance between the embedded copyright information and the taken out copyright information is examined, and a judgment made as to whether or not the image is one for which one holds the copyright. Here, the copyright information is preferably embedded so that it remains, even if the size of the image is changed, or editing etc. of the image is carried out. Furthermore, with the copyright information, not only image information but also for example voice, video etc. information can be embedded.

The server software 14 carries out referencing, updating etc. of the HTML document registered in the database 12 in response to a request from the client 20, and returns the result to the client 20.

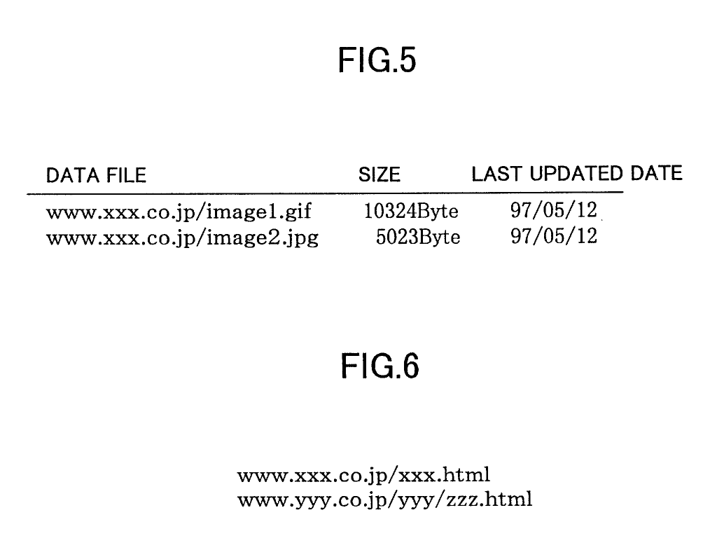

On the other side, the client 20 comprises a browser 22, copyright inspection software 24, an attribute recording file 26 (attribute recording device, attribute recording method, attribute recording function), and a link table file 28 (activation recording device, activation recording method, activation recording function). The browser 22 provides an operating environment for a user carrying out operation of the HTML document. The operating environment is designed using for example a GUI (graphic user interface) so that operation can be easily carried out. The copyright inspection software 24, at the time of inspecting whether or not the digital data for which one holds the copyright is being used improperly, carries out automatic inspection of the copyright with respect to a plurality of HTML documents. In the attribute recording file 26 is recorded attributes of digital data for which the copyright has been inspected. As the attributes of the digital data, then as shown in FIG. 5, there is recorded at least a file size for URLs (Uniform Resource Locators) showing predetermined locations of the digital data, and the last update date. In the link table file 28 as shown in FIG. 6, is registered URLs for which copyright inspection has been completed. However, instead of the link table file 28, the URLs for which inspection has been completed may be registered in the memory.

The copyright inspection software 24 realizes by means of a program, a copyright inspection device, a hyperlink information take out device, a recursive activation device, an attribute take out device, and an automatic activation device, a copyright inspection step, a hyperlink information take out step, a recursive activation step, an attribute take out step, and an automatic activation step, a copyright inspection function, a hyperlink information take out function, a recursive activation function, an attribute take out function, and an automatic activation function.

The WWW server 10 and the client 20 are connected by means of a communication protocol referred to as HTTP (Hyper Text Transfer Protocol). When the URL is sent to the server software 14 from the browser 22, the server software 14 operates the database 12 and returns the HTML document to the browser 22.

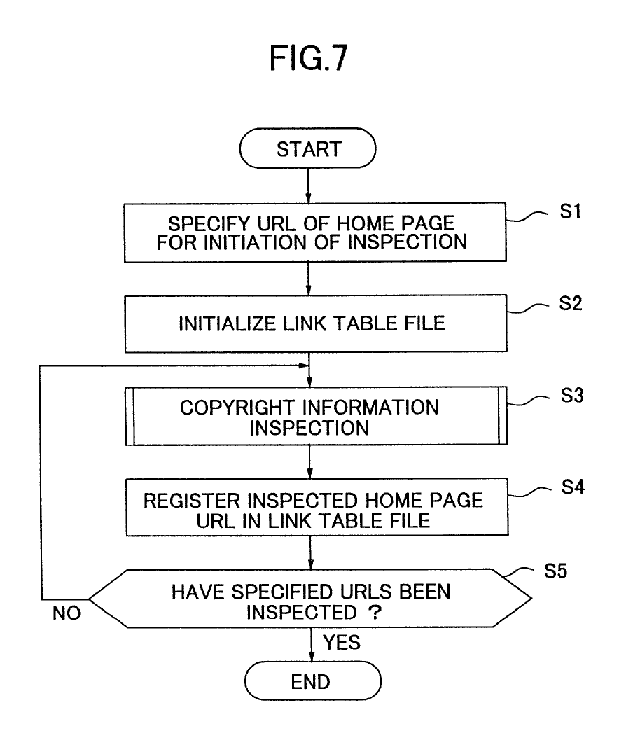

Next is a description of the operation of the copyright inspection apparatus of the above construction, with reference to the system structure diagram of FIG. 1 and the flow charts of FIG. 7 through FIG. 9.

FIG. 7 shows a main routine for carrying out copyright inspection, executed for example when a user instructs initiation of copyright inspection.

In step 1 (abbreviated to S1 in the figure and similarly with subsequent steps), at least one URL of a home page for which inspection of copyright is to be initiated is specified. With the URL specified, in order to prevent overflow of the stack, this may be limited to a predetermined value.

In step 2, the link table file 28 is initialized. That is to say, the link table file 28 is cleared and the URLs for which copyright inspection has been completed are put into a not yet registered condition.

In step 3, the subroutine for carrying out copyright inspection is called, with the specified URL as a parameter.

In step 4, the URL showing the home page for which copyright has been inspected is registered in the link table file 28.

In step 5, it is judged if copyright has been inspected for all of the URLs specified in step 1. If judged that all of the URLs have been inspected, inspection is terminated (YES), while if judged that all URLs have not been inspected, control returns to step 3 (NO).

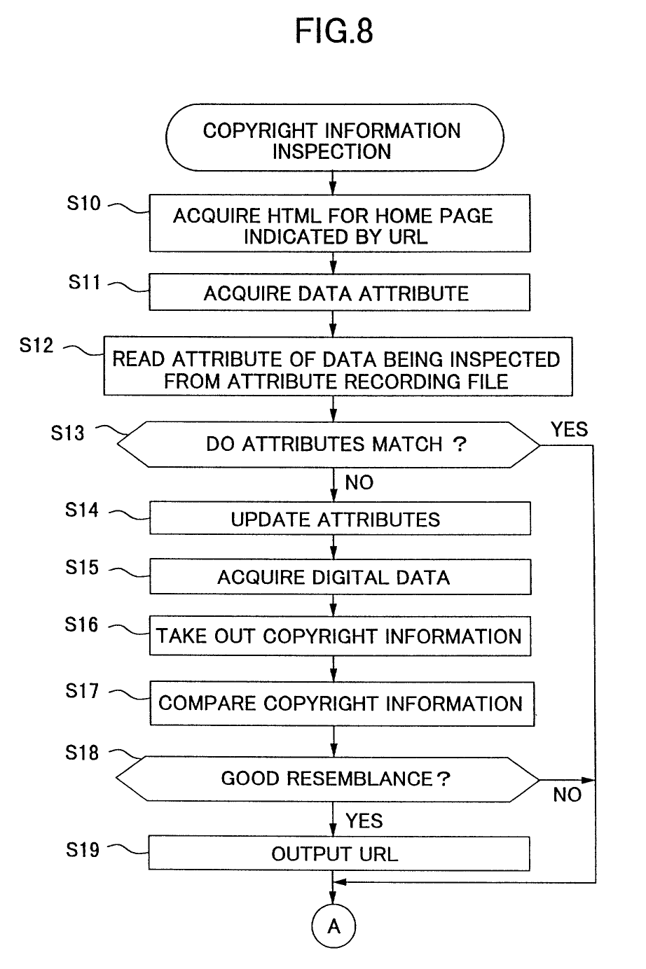

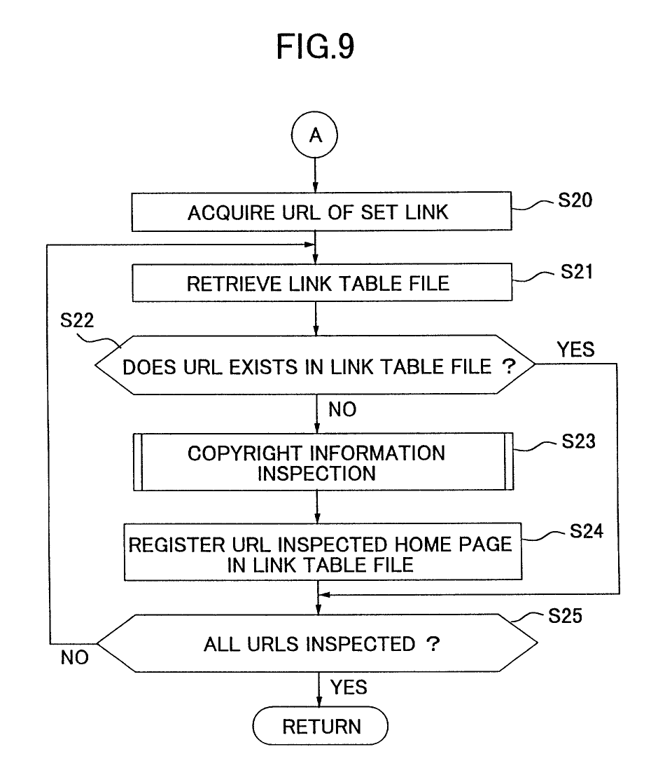

FIG. 8 and FIG. 9 show a subroutine for actually carrying out copyright inspection.

In step 10, the HTML document for the home page shown by the URL as a parameter is acquired. That is to say, an HTML document such as shown in FIG. 2, is acquired.

In step 11, the attribute of the digital data used in the acquired HTML document is acquired. With the HTML document shown in FIG. 2, the images, more specifically, the attributes (refer to FIG. 5) of the image1.tif (TIFF format) and image2.jpg (JPEG format) are acquired. Here, the processing of step 11 corresponds to the attribute take out device, the attribute take out step, and the attribute take out function.

In step 12, the attribute of the digital data being the object of inspection is read from the attribute recording file 26. That is to say, the attribute of the digital data (image1.tif, image2.jpg) being the object of inspection is read from the attribute recording file 26, and the file size and the last update date acquired.

In step 13 it is judged if the attribute acquired in step 11 and the attribute acquired in step 12 match. In the case where both the file size and the last update date match, the attributes are judged to match. Then, if the attributes match, control proceeds to step 20 (YES), while if the attributes do not match, control proceeds to step 14 (NO).

Incidentally, with digital data such as for images, even in the present day with advances in compression technology such as JPEG, transmission takes time, and the network is subjected to a heavy load. However, with the processing of step 11 through step 13, in the case where the attribute for the digital data being the object of inspection, and the attribute for the digital data recorded in the attribute recording file 26 match, copyright inspection is not carried out. This is because, in the case where alteration or the like of the digital data has been made, the file size and the last update date are changed, and hence, if the attributes for the previous inspection and the current inspection match, it can be judged that alteration or the like has not been made. Consequently, the quantity of digital data being the object of inspection can be reduced and inspection time shortened, making efficient inspection possible.

In step 14, the attribute recording file 26 is updated based on the attribute of the digital data being the object of inspection. That is to say, the attribute of the digital data being the object of inspection recorded in the attribute recording file 26 is made to be the attribute of the digital data being the object of inspection.

In step 15, the digital data used in the HTML document acquired in step 10 is acquired. With the HTML document shown in FIG. 2, the images for image1.tif(TIFF format) and image2.jpg (JPEG format)) are acquired.

In step 16, the copyright information is taken out from the acquired digital data. Taking out the copyright information may involve for example, selecting a method for taking out copyright information from the extension etc. of the file name of the digital data being the object of inspection, and then taking out the copyright information using the selected take out method.

In step 17, the taken out copyright information and the copyright information to be inspected are compared, and a statistical method applied to obtain a correlation between the two. To obtain the correlation, for example, the respective bits constituting the taken out copyright information and the respective bits constituting the copyright information to be inspected are compared for every one bit, and the number of bits matching obtained. The correlation between the two can then be obtained by applying the statistical method.

In step 18, based on the obtained correlation, it is judged if there is a good resemblance between the taken out copyright information and the copyright information to be inspected. Then if judged that the resemblance between the two is good, control proceeds to step 19 (YES), while if judged that the resemblance between the two is poor, control proceeds to step 20 (NO).

In step 19, processing is carried out for when judged that the resemblance between the taken out copyright information and the copyright information to be inspected is good, and the URL, file name etc. for the digital data judged to have good resemblance are output. The digital data URL etc. may be output for example to an output device such as a printer, monitor or the like.

Here, the processing of step 13, and step 15 through step 19, corresponds to the copyright inspection device, the copyright inspection step, and the copyright inspection function.

With the processing of step 14 through step 19, a comparison is made between the copyright information taken out from the digital data being the object of inspection, and the copyright information to be inspected. Then if judged that the resemblance between the two is good, the URL etc. for the digital data being the object of inspection, is output to the output device. Consequently, by viewing the URL etc. output to the output device, the user inspecting the copyright information can catch the home page etc. in which is carried out the improper use of the digital data.

In step 20, the URL of the set hyperlink is acquired from the HTML document acquired in step 10. With the HTML document shown in FIG. 2, the URLs “HTTP//www.yyy.jp” and “HTTP//www.zzz.jp” are acquired from the description <A “HREF=“HTTP://www.yyy.jp/”> go to YYY Home Page </A> and <A HREF=“HTTP://www.zzz.jp/”> go to ZZZ Home Page </A>. That is to say, the fact that reference to the home pages indicated by “HTTP//www.yyy.jp” and “HTTP//www.zzz.jp” is carried out from the home page shown in FIG. 3, is acquired. Here, the processing of step 20 corresponds to the hyperlink information take out device, the hyperlink information take out step, and the hyperlink information take out function.

In step 21, the link table file 28 is retrived to judge if the URL acquired in step 20 is registered. With the HTML document shown in FIG. 2, it is judged if the URL “HTTP//www.yyy.jp” or “HTTP//www.zzz.jp” is registered.

In step 22, branch processing is carried out based on whether or not the URL being the object of inspection exists in the link table file 28. That is to say, if the URL being the object of inspection exists, control proceeds to step 25 (YES), while if the URL being the object of inspection does not exist, control proceeds to step 23 (NO).

In step 23, the subroutine for carrying out inspection of the copyright is recursively called with the URL being the object of inspection, that is the URL indicating the referable home page, as a parameter. In short, one calls oneself. When recursive calling is carried out, in order to prevent stack overflow, a limit can be set for controlling the depth (number of times) of the recursive calling.

Here, the processing of step 21 through step 23 corresponds to the recursive activation device, the recursive activation step, and the recursive activation function.

In step 24, the URL indicating the home page for which copyright has been inspected is registered in the link table file 28.

In step 25, it is judged if inspection of the copyright has been carried out for all of the home pages indicated by the URL acquired in step 20. Then, if judged that inspection has been carried out for all of the home pages, control returns to the main routine (YES), while if judged that inspection has not been carried out for all of the home pages, control returns to step 21 (NO). In the case of the HTML document shown in FIG. 2, once inspection of the copyright has been carried out for the URLs “HTTP//www.yyy.jp” and “HTTP//www.zzz.jp”, control returns to the main routine.

With the processing of step 20 through step 25, the subroutine for inspection of the copyright is recursively called, with URLs indicating the other referable home pages, as a parameter. Therefore, by merely specifying at least one home page for inspection of the copyright, inspection of the copyright is automatically carried out one by one for the other home pages referable from the relevant home page. Consequently, inspection of the copyright of the digital data is automatically carried out for a wide range of home pages.

Moreover, with home pages on the Internet, there are cases where hyperlinks are set mutually. Therefore, when inspection of the copyright is carried out automatically, processing can get caught in an endless loop and never finish. However, due to the processing of step 21 and step 22, inspection of copyright is not carried out with respect to the URL registered in the link table file 28, and hence this undesirable situation is avoided.

An explanation of the operation of the link table file 28, taking a specific example, is as follows. At first, at the time of inspecting the copyright of the home page (http://www.yyy.jp) referable from the home page (http://www.xxx.jp) initiating the inspection of copyright, it is judged if “http://www.yyy.jp” has already been registered in the link table file 28. In this case, since in step 2 initialization of the link table file 28 is carried out, then “http://www.yyy.jp” is not yet registered and hence inspection of copyright is carried out. Then once inspection of copyright has been carried out, “http://www.yyy.jp” is registered in the link table file 28.

After this, at the time of inspecting the copyright of the other referable home page (http://www.zzz.jp), it is judged if “http://www.zzz.jp” has already been registered in the link table file 28. In this case, since only “http://www.yyy.jp” has been registered in the link table file 28, inspection of copyright is carried out. Then once inspection of copyright has been carried out, “http://www.zzz.jp” is registered in the link table file 28.

In this condition, when inspection of copyright is again carried out with respect to the home page indicating “http://www.yyy.jp” or “http://www.zzz.jp”, the link table file 28 is retrieved. In this case, since “http://www.yyy.jp” and “http://www.zzz.jp” have already been registered in the link table file 28, the subroutine shown in FIG. 8 and FIG. 9 is not recursively called.

Consequently, inspection of the copyright is not carried out with respect to home pages which have already been inspected, and entrapment in an endless loop is prevented.

With the processing of FIG. 7 through FIG. 9 as described above, if at least one home page for starting the inspection of copyright is specified, inspection of copyright is carried out with respect to the digital data used in that home page. Then, if judged that the possibility of improper use of the digital data being the object of inspection is high, the URL etc. of that digital data is output to the output device. After this, one recursively calls oneself from the specified home page with the URL indicating the referable home page, as a parameter. Consequently, inspection of the copyright of the digital data can be automated, and hence inspection for improper use of digital data, which has heretofore been inadequate, can be adequately carried out.

Further, with a home page on the Internet, since frequent modification etc. is common, then inspection of the copyright can be automatically carried out at predetermined intervals or predetermined times. For example, inspection of copyright may be executed once a week, at twelve o'clock each Saturday. If this is done, then the load on the user carrying out inspection of the copyright can be reduced, and also inspection of copyright can be effectively carried out. Here, this processing corresponds to the automatic activation device, the automatic activation step and the automatic activation function.

If a program for realizing such a function is recorded on a portable medium such as a magnetic tape, magnetic disc, magnetic drum, IC card, CD-ROM etc., then the digital data copyright inspection program according to the present invention can be distributed in the market. Moreover, a person acquired such a recording medium can easily construct a digital data copyright inspection apparatus using a standard computing system.

What we claimed are:

1. An apparatus for inspecting the copyright of digital data on a network comprising;
data providing means for providing digital data on a network, and
copyright inspection means for taking out copyright information from the digital data provided by said data providing means, and inspecting the copyright of said digital data based on the taken out copyright information, and in which is set a hyperlink for enabling reference from one data providing means to a referenced data providing means, wherein said apparatus further comprises;
hyperlink information take out means for taking out hyperlink information from said data providing means which provides said digital data, when the copyright of the digital data has been inspected by said copyright inspection means, and
recursive activation means for recursively activating said copyright inspection means with respect to said referenced data providing means which is specified by the hyperlink information taken out by said hyperlink information take out means.

2. An apparatus for inspecting the copyright of digital data on a network according to claim 1, wherein there is provided activation recording means for recording said data providing means for providing the digital data for which the copyright has been inspected, when said copyright inspection means is activated by said recursive activation means, and
said recursive activation means skips activation of said copyright inspection means with respect to the data providing means recorded in said activation recording means.

3. An apparatus for inspecting the copyright of digital data on a network according to claim 1, wherein there is provided attribute recording means for recording attributes of digital data for which the copyright has been inspected by said copyright inspection means, and
attribute take out means for taking out the attribute of the digital data for which the copyright is to be inspected by said copyright inspection means,
and said copyright inspection means inspects the copyright of said digital data when the attribute taken out by said attribute take out means and the attribute recorded in said attribute recording means do not match.

4. An apparatus for inspecting the copyright of digital data on a network according to claim 1, wherein there is provided automatic activation means for automatically activating said copyright inspection means in accordance with a previously set schedule.

5. A method of inspecting the copyright of digital data on a network comprising;
a data providing step for providing digital data on a network, and
a copyright inspection step for taking out copyright information from the digital data provided by said data providing step, and inspecting the copyright of said digital data based on the taken out copyright information, and in which is set a hyperlink for enabling reference from one data providing step to a referenced data providing step, wherein said method further comprises;
a hyperlink information take out step for taking out hyperlink information from said data providing step which provides said digital data, when the copyright of the digital data has been inspected by said copyright inspection step, and
a recursive activation step for recursively activating said copyright inspection step with respect to said referenced data providing step which is specified by the hyperlink information taken out by said hyperlink information take out step.

6. A method of inspecting the copyright of digital data on a network according to claim 5, wherein there is provided an activation recording step for recording said data providing step for providing the digital data for which the copyright has been inspected, when said copyright inspection step is activated by said recursive activation step, and
said recursive activation step skips activation of said copyright inspection step with respect to the data providing step recorded in said activation recording step.

7. A method of inspecting the copyright of digital data on a network according to claim 5, wherein there is provided an attribute recording step for recording attributes of digital data for which the copyright has been inspected by said copyright inspection step, and
an attribute take out step for taking out the attribute of the digital data for which the copyright is to be inspected by said copyright inspection step,
and said copyright inspection step inspects the copyright of said digital data when the attribute taken out by said attribute take out step and the attribute recorded in said attribute recording step do not match.

8. A method of inspecting the copyright of digital data on a network according to claim 5, wherein there is provided an automatic activation step for automatically activating said copyright inspection step in accordance with a previously set schedule.

9. A recording medium on which is recorded a program for inspecting the copyright of digital data on a network comprising;
a data providing function for providing digital data on a network, and
a copyright inspection function for taking out copyright information from the digital data provided by said data providing function, and inspecting the copyright of said digital data based on the taken out copyright information,
and in which is set a hyperlink for enabling reference from one data providing function to a referenced data providing function, wherein said program further realizes;
a hyperlink information take out function for taking out hyperlink information from said data providing function which provides said digital data, when the copyright of the digital data has been inspected by said copyright inspection function, and
a recursive activation function for recursively activating said copyright inspection function with respect to said referenced data providing function which is specified by the hyperlink information taken out by said hyperlink information take out function.

10. A recording medium on which is recorded a program for inspecting the copyright of digital data on a network according to claim 9, wherein there is provided an activation recording function for recording said data providing function for providing the digital data for which the copyright has been inspected, when said copyright inspection function is activated by said recursive activation function, and said recursive activation function skips activation of said copyright inspection function with respect to the data providing function recorded in said activation recording function.

11. A recording medium on which is recorded a program for inspecting the copyright of digital data on a network according to claim 9, wherein there is provided an attribute recording function for recording attributes of digital data for which the copyright has been inspected by said copyright inspection function, and an attribute take out function for taking out the attribute of the digital data for which the copyright is to be inspected by said copyright inspection function,
and said copyright inspection function inspects the copyright of said digital data when the attribute taken out by said attribute take out function and the attribute recorded in said attribute recording function do not match.

12. A recording medium on which is recorded a program for inspecting the copyright of digital data on a network according to claim 9, wherein there is provided an automatic activation function for automatically activating said copyright inspection function in accordance with a previously set schedule.
